(19) United States
(12) Patent Application Publication
(10) Pub. No.: US 2021/0008936 A1
(43) Pub. Date: Jan. 14, 2021

(54) SELF-INFLATION DEVICE FOR A TIRE

(71) Applicant: YADIN TRP LTD, Tel-Aviv (IL)

(72) Inventor: Eran ALMOG, Kibbutz Maagan Michael (IL)

(73) Assignee: Yadin TRP LTD, Tel-Aviv (IL)

(21) Appl. No.: 16/958,716

(22) PCT Filed: Dec. 28, 2018
(86) PCT No.: PCT/IL2018/051406

§ 371 Date: Jun. 28, 2020

Related U.S. Application Data
(63) Continuation-in-part of application No. 15/856,112, filed on Dec. 28, 2017, now Pat. No. 10,300,749.

(51) Int. Cl. B60C 23/12; B60C 29/02; B60C 29/00; B60C 23/00

(52) U.S. Cl. CPC B60C 23/126; B60C 23/004; B60C 29/002; B60C 29/02

(57) ABSTRACT

A self-inflation device for maintaining pressure in a tire includes a piston compartment, a piston, and an intake opening for fluidically connecting the piston compartment to ambient atmosphere. A valve controls airflow between the piston compartment and the inner space of the tire. Airflow between the piston compartment and the inner space is allowed when the valve is opened and prevented when the valve is closed. The piston is movable within the piston compartment between an air intake position, in which the intake opening fluidically connects the piston compartment and the ambient atmosphere, and a compression position, in which the piston fluidically seals the piston compartment from the intake opening, thereby creating a compression chamber. The piston opens and closes the valve, and cycles between the air intake and the compression positions, through application of centrifugal force onto the self-inflation device by rotation of the tire.

### RELATED APPLICATIONS

This application claims the benefit of priority from U.S. patent application Ser. No. 15/856,112 filed on Dec. 28, 2017, the contents of which are incorporated herein by reference in their entirety.

### FIELD AND BACKGROUND OF THE INVENTION

The present invention, in some embodiments thereof, relates to a self-inflation device for maintaining pressure in a tire and, more particularly, but not exclusively, to a device which inflates the tire using centrifugal force and tire air pressure.

Most types of wheel tires comprise compressed air. During use of the wheel, the air pressure in a tire gradually decreases. It is desirable to preserve the air pressure within a predetermined range, and ideally constant, to prevent excessive fuel consumption, tire wear and impaired steering ability which may compromise driving safety.

Apart from regular periodic inflation of the tire, using for example a compressor, some devices exist for maintaining air pressure in a tire. These devices may include a high pressure air reservoir connected to the tire, electronic means for detecting low pressure and/or other components.

### SUMMARY OF THE INVENTION

According to an aspect of some embodiments of the present invention, there is provided a self-inflation device for maintaining pressure in a tire. The self-inflation device includes a piston compartment and a piston housed in the piston compartment. An intake opening is configured to be external to an inner space of the tire when the self-inflation device is installed in an operational position. The intake opening configured for fluidically connecting the piston compartment to ambient atmosphere external to the inner space. A valve controls airflow between the piston compartment and the inner space of the tire. Airflow between the piston compartment and the inner space is allowed when the valve is opened and prevented when the valve is closed. The piston is movable within the piston compartment between an air intake position in which the intake opening fluidically connects the piston compartment and the ambient atmosphere, and a compression position, in which the piston fluidically seals the piston compartment from the intake opening, thereby creating a compression chamber. When the self-inflation device is installed in the operational position, the piston opens and closes the valve, and cycles between the air intake and the compression positions, through application of centrifugal force onto the self-inflation device by rotation of the tire. Advantageously, the self-inflation device adjusts the air pressure of the tire using centrifugal force from the tire's rotation, without requiring a pump or other external source of pressure.

In some embodiments, the self-inflation device further comprises a pin located in the piston compartment and configured to press the valve when the piston is in the compression position, to thereby open the valve. Optionally, the pin is located in an opposing side of the piston compartment to the valve. Advantageously, the device may be configured to open the valve with the pin only when the pressure in the compression chamber reaches a predefined pressure, thereby enabling precise control of the pressure in the tire.

In some embodiments, the self-inflation device comprises a body. The piston compartment is configured on one side of the body. A sub-pressure compartment configured on an opposing side of the body relative to the piston compartment. The sub-pressure compartment includes a plunger slidably configured therein. The plunger is movable within the sub-pressure compartment between an open position, in which air fills into the sub-pressure compartment via the air intake opening, and a closed position, in which the plunger compresses the air within the sub-pressure compartment. An interior air channel within the body fluidically connects between the sub-pressure compartment and the piston compartment. In the air intake position, the piston compartment is configured to receive air from the sub-pressure compartment via the interior air channel. Advantageously, the sub-pressure compartment provides a source of pressurized air to introduce into the piston compartment.

Optionally, the sub-pressure compartment has a larger diameter than the piston compartment. Advantageously, the larger diameter of the sub-pressure compartment will cause the internal pressure of the tire to exert greater pressure on the plunger than on the piston, thus enabling them to operate independently of each other.

Optionally, the plunger is at least partially hollow. Advantageously, the hollowness of the plunger allows calibration of the pressure in the sub-pressure compartment relative to the pressure in the piston compartment.

Optionally, the self-inflation device further comprises a first connecting rod extending laterally from the piston along a shaft axis; a second connecting rod extending laterally from the plunger along the shaft axis; a crankshaft configured perpendicular to the first and second connecting rods and extending therebetween; and a weight attached to the crankshaft between the first and second connecting rods, such that rotation of the weight causes corresponding reciprocal movement of the first and second connecting rods. The first and second connecting rods respectively define retracted positions and extended positions. The first connecting rod and second connecting rod are attached to the crankshaft at rotationally opposite positions, such that when one of the first and second connecting rod is in its retracted position, the other is in its extended position, and vice versa. Advantageously, the reciprocal movement of the first and second connecting rods permits efficient flow of air from the sub-pressure compartment to the piston compartment, and from the piston compartment to the valve.

Optionally, when the self-inflation device is installed in the operational position and when the wheel is at rest, a center of mass of the weight is below the shaft axis, the second connecting rod is in its extended position causing the plunger to reduce the volume of the sub-pressure compartment, and the piston is in a retracted position permitting airflow between the interior air channel and the piston compartment. Advantageously, this configuration allows for infusion of air into the self-inflation device when it is at rest.

Optionally, application of centrifugal force by rotation of the tire causes the weight to rotate. The crankshaft is configured to convert the rotational movement of the weight into linear movement of the first and second connecting rods and thereby cause corresponding reciprocal movement of the plunger and the piston. Advantageously, the centrifugal force caused by rotation of the tire thus causes synchronized movement of the plunger and piston, without requiring an additional power source.

Optionally, application of centrifugal force when the self-inflation device is in the rest position causes the weight to rotate to a first rotation position. In the first rotation position, the center of mass of the weight is behind the crankshaft relative to the body, the plunger is at least partially retracted to increase the volume of air entering the sub-pressure compartment from the intake opening, and the piston is at least partially extended such that the first sealing component prevents airflow between the interior air channel and the piston compartment and thereby creates the compression chamber. Additionally, application of centrifugal force when the self-inflation device is in the first rotation position causes the weight to rotate to a second rotation position. In the second rotation position, the center of mass of the weight is above the crankshaft, the plunger is fully retracted, and the piston is fully extended to the valve opening position to cause the valve to open and air to enter the tire. Additionally, application of centrifugal force when the self-inflation device is in the second rotation position causes the weight to rotate to a third rotation position. In the third rotation position, the center of mass of the weight is parallel to the crankshaft, the plunger is at least partially extended to force air from the sub-pressure compartment into the interior air channel, and the piston is at least partially retracted to form a vacuum in the piston compartment. Advantageously, the self-inflation device is configured to cycle between these rotation positions and open and close the valve through application of centrifugal force, without requiring additional force to rotate the weight or open the valve.

In some embodiments, the piston has a piston opening internal to the inner space. The piston is moved to a pulled position by centrifugal force applied by rotation of the tire to open the intake opening in the air intake position, and moved to a pushed position by air pressure from the inner space to block the intake opening and create the compression chamber within the piston compartment in the compression position. The valve is opened when the piston is in the pushed position. Advantageously, the piston moves between the pulled and pushed positions by application of centrifugal force by rotation of the tire, without requiring additional force to move the piston or open the valve.

Optionally, the piston opening is a channel passing along the piston. Advantageously, this orientation allows the piston and piston opening to be constructed compactly.

Optionally, the self-inflation device further comprises an adjustment mechanism for adjusting the maximum pressure of the compression chamber. More optionally, the adjustment mechanism adjusts the size of the compression chamber. More optionally, the adjustment mechanism is a screw. Advantageously, by controlling the maximum pressure of the compression chamber, the device can thereby be used to control the internal pressure of the tire.

Optionally, the self-inflation device further comprises a sealing component positioned around the piston and pressed into the piston compartment. More optionally, the sealing component is a U-Cup seal. More optionally, the sealing component is an O-ring. Advantageously, the sealing component may provide an airtight seal within the piston compartment.

Optionally, the valve is a standard pneumatic valve stem.

Optionally, the self-inflation device further comprises a tire valve portion having a one way inflation channel and an intake channel attached to the intake opening; wherein the tire valve portion is positioned at a tire valve opening of the tire. More optionally, the one way inflation channel includes an inflation valve. Advantageously, in such embodiments, the self-inflation device is installed in an efficient manner in a tire without a need for a separate installation location for the tire valve and the self-inflation device.

Optionally, the self-inflation device further comprises a mount adapted to fixate the body in relation to the tire. Optionally, the self-inflation device is mounted on a rim holding the tire.

Advantageously, the mount secures the self-inflation device to the tire.

According to an aspect of some embodiments of the present invention, there is provided a method of maintaining pressure in a tire by a self-inflation device. The method comprises moving a piston within a piston compartment between an air intake position in which an intake opening fluidically connects the piston compartment and the ambient atmosphere, and a compression position, in which the piston fluidically seals the piston compartment from the intake opening, thereby creating a compression chamber. The method further comprises opening and closing a valve with the piston, wherein airflow between the compression chamber and the inner space is allowed when the valve is opened and prevented when the valve is closed, and cycling between the air intake and the compression positions. The opening and cycling steps are performed through application of centrifugal force onto the self-inflation device by rotation of the tire. Advantageously, the method adjusts the air pressure of the tire using centrifugal force from the tire's rotation, without requiring a pump or other external source of pressure.

In some embodiments, the self-inflation device comprises a body, and the piston compartment is configured on one side of the body. The self-inflation device further comprises a sub-pressure compartment configured on an opposing side of the body and a plunger slidably configured within the sub-pressure compartment. An interior air channel within the body is for connecting air between the sub-pressure compartment and the piston compartment. The piston compartment is connectable to the intake opening via the sub-pressure compartment and the interior air channel. A first connecting rod extends laterally from the piston along a shaft axis, and a second connecting rod extends laterally from the plunger along the shaft axis. A crankshaft is configured perpendicular to the first and second connecting rods and extends therebetween. A weight is attached to the crankshaft between the first and second connecting rods, such that rotation of the weight causes corresponding reciprocal movement of the first and second connecting rods. The first connecting rod and second connecting rod are attached to the crankshaft at rotationally opposing positions, such that when the plunger is extended, the piston is retracted, and vice versa. In such embodiments, the method further comprises rotating the weight with centrifugal force applied by rotation of the tire; converting rotational motion of the weight into linear motion of the first and second connecting rods; and reciprocally moving the plunger and the piston. Advantageously, the centrifugal force caused by rotation of the tire thus causes synchronized movement of the plunger and piston, without requiring an additional power source.

In some embodiments, the piston has a piston opening internal to an inner space of the tire. In such embodiments, the method further comprises: moving the piston to a pulled position by application of centrifugal force applied by rotation of the tire to open the intake opening; moving the piston to a pushed position by air pressure from the inner space to block the intake opening and create the compression chamber within the piston compartment; and opening the valve when the piston is in the pushed position. Advantageously, the piston moves between the pulled and pushed positions by application of centrifugal force by rotation of the tire, without requiring additional force to move the piston or open the valve.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are cross section illustrations of a self-inflation device for maintaining pressure in a tire via centrifugal force and tire air pressure with a piston in a pulled position and in a pushed position, respectively, according to some embodiments of the present invention;

FIG. 2 is a cross section illustration of a self-inflation device, positioned on a rim of a wheel, according to some embodiments of the present invention;

FIG. 3 is a flowchart schematically representing a method for maintaining pressure in a tire by a self-inflation device, according to some embodiments of the present invention;

FIGS. 4A and 4B are cross section illustrations of a self-inflation device having an adjustment mechanism, with a piston in a pulled position and in a pushed position, respectively, according to some embodiments of the present invention;

FIGS. 5A and 5B are further schematic illustrations of the self-inflation device of FIGS. 4A and 4B, respectively, according to some embodiments of the present invention;

FIGS. 6A and 6B are cross section illustrations of a self-inflation device having a mount, with a piston in a pulled position and in a pushed position, respectively, according to some embodiments of the present invention;

FIG. 7 is a cross section illustration of a self-inflation device, positioned on rim of a wheel by a mount, according to some embodiments of the present invention;

FIGS. 8A and 8B are different cross section illustrations of a self-inflation device having a tire valve portion, according to some embodiments of the present invention;

FIG. 9 is a cross section illustration of a self-inflation device having a tire valve portion positioned at a tire valve opening in a rim of a wheel, according to some embodiments of the present invention;

FIG. 10 is a cross section illustration of a self-inflation device having a tire valve portion held by a mount, positioned at a tire valve opening in a rim of a wheel, according to some embodiments of the present invention;

FIG. 11 is a left perspective view of another embodiment of a self-inflation device, according to some embodiments of the present invention;

FIG. 12 is a top view of the self-inflation device of FIG. 11, according to some embodiments of the present invention;

FIG. 13 is a left side section view of the self-inflation device of FIG. 11, according to some embodiments of the present invention;

FIG. 14 is a left side view of the self-inflation device of FIG. 11, according to some embodiments of the present invention;

FIG. 15 is a bottom section view of the self-inflation device of FIG. 11, according to some embodiments of the present invention;

FIG. 16A is a top view of a crankshaft of the self-inflation device of FIG. 11, according to some embodiments of the present invention;

FIG. 16B is a perspective view of a crankshaft of the self-inflation device of FIG. 11, according to some embodiments of the present invention;

FIG. 16C is a top view of components of a crank system of the self-inflation device of FIG. 11, according to some embodiments of the present invention;

FIG. 16D is a rear view of components of a crank system of the self-inflation device of FIG. 11, according to some embodiments of the present invention;

FIG. 17A is a left side view of the self-inflation device of FIG. 11 in a rest position, according to some embodiments of the present invention;

FIG. 17B is a top view of the self-inflation device of FIG. 11 in the rest position of FIG. 16A, according to some embodiments of the present invention;

FIG. 18A is a left-side view of the self-inflation device of FIG. 11 in a first rotation position, according to some embodiments of the present invention;

FIG. 18B is a top view of the self-inflation device of FIG. 11 in the first rotation position, according to some embodiments of the present invention;

FIG. 19A is a left-side view of the self-inflation device of FIG. 11 in a second rotation position, according to some embodiments of the present invention;

FIG. 19B is a top view of the self-inflation device of FIG. 11 in the second rotation position, according to some embodiments of the present invention;

FIG. 20A is a left-side view of the self-inflation device of FIG. 11 in a third rotation position, according to some embodiments of the present invention;

FIG. 20B is a top view of the self-inflation device of FIG. 11 in the third rotation position, according to some embodiments of the present invention;

FIG. 21 is a flowchart schematically representing a method for maintaining pressure in a tire by the self-inflation device of FIG. 11, according to some embodiments of the present invention;

FIG. 22 is a schematic illustration the self-inflation device of FIG. 11 positioned at a tire valve opening in a rim of a wheel, according to some embodiments of the present invention;

FIG. 23 is a cross-section illustration of the self-inflation device of FIG. 11 positioned in the rim of a wheel as depicted in FIG. 22, according to some embodiments of the present invention; and

FIG. 24 is a close-up view of the cross-section illustration of FIG. 23, according to some embodiments of the present invention.

### DESCRIPTION OF SPECIFIC EMBODIMENTS OF THE INVENTION

The present invention, in some embodiments thereof, relates to a self-inflation device for maintaining pressure in a tire and, more particularly, but not exclusively, to a device which inflates the tire using centrifugal force and tire air pressure.

According to some embodiments of the present invention, there is provided a device which is attached to a wheel having a tire, and located at least partially inside the tire of the wheel and at least connected to the air outside the tire. The device includes a body, such as a tube, and a piston inserted within the body. When the wheel is turning, centrifugal force moves the piston along the body, which opens an intake opening of the body, allowing air to enter the body from outside. When the wheel slows its turning, pressure from inside the tire moves the piston towards the chamber, closing the intake opening and creating a compression chamber between the body and the piston. This is optionally done by a seal ring that is placed around the piston. This is possible since the surface of the piston which is exposed to the inner space of the tire is larger than the surface exposed to the compression chamber. Unlike existing devices, the current device includes a springless mechanism, and the piston is pushed by pressure from inside the tire, so no spring or other flexible elements are required, which may wear during use.

The pressure from inside the tire further moves the piston to create air pressure within the compression chamber, until a valve separating the inner space of the tire and the compression chamber, for example a standard valve core attached to the piston, is opened. The valve may be opened by a pin located in an opposing side of the compression chamber. When the valve is opened, air may flow between the inner space of the tire and the compression chamber to equalize the pressures, for example via a channel passing along the piston. The device therefore preserves the pressure in the tire, by allowing bidirectional flow of air to correct the pressure when it is too high or too low. This is unlike existing devices, which may increase pressure but cannot lower the pressure when too high.

When the pressure in the compression chamber is higher than the pressure in the tire, air flows from the compression chamber to the tire, filling the tire with more air. This may happen when the pressure in the tire is insufficient. When the wheel turns again, the process is repeated, until the pressure in the tire is sufficient. When the pressures in the compression chamber and in the tire are equal, there is no airflow between them. When the pressure in the compression chamber is lower than the pressure in the tire, air flows from the tire to the compression chamber. The air is then released outside when the wheel turns again. This may happen when there is too much pressure in the tire.

The size of the compression chamber and/or the opening of the valve may be adjusted, for example by a screw located in an opposing size of the body to the piston, and may include the pin which opens the valve. This adjusts the desired pressure in the tire, for example for different types of tires and/or vehicles.

Optionally, the device includes a tire valve portion having a one way inflation channel and may be positioned at a tire valve opening of the tire. This allows the device to be used without any needed modifications to the tire or rim.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

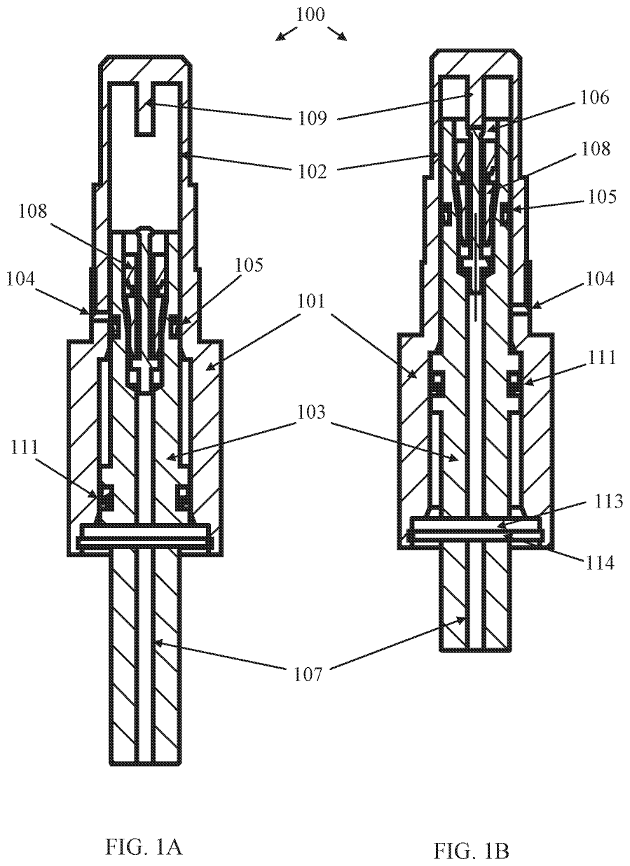

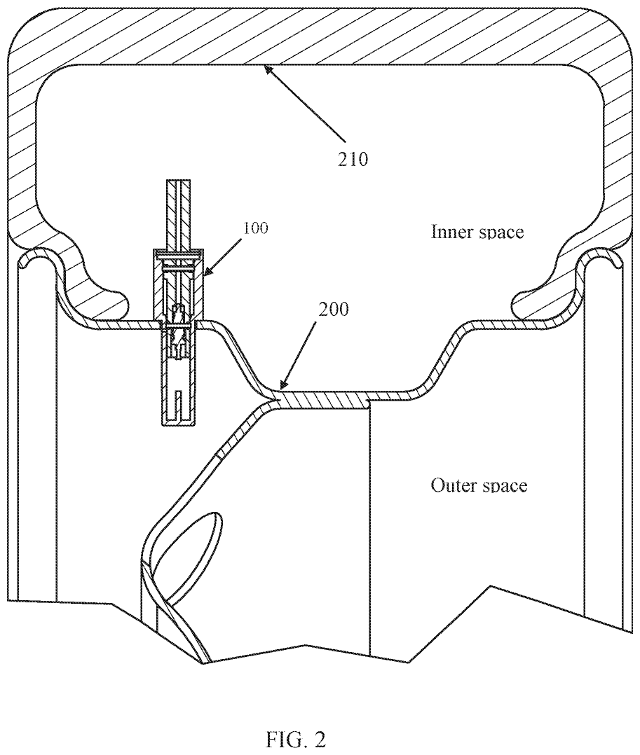

Referring now to the drawings, FIGS. 1A and 1B are cross section illustrations of a self-inflation device for maintaining pressure in a tire via centrifugal force and tire air pressure with a piston in a pulled position and in a pushed position, respectively, according to some embodiments of the present invention.

A self-inflation device 100 includes a body 101 having a piston compartment 102. Body 101 may have, for example, a cylindrical shape, or any other shape which may include piston compartment 102, which may be a tube fitting a piston. Body 101 and/or any other part of self-inflation device 100 may be made of any solid material, for example metal such as steel.

A piston 103 housed in piston compartment 102, is a cylinder fitting closely within the tube and is free to move up and down along piston compartment 102.

Body 101 is positioned perpendicular to the rotation axis of the wheel, so that piston 103 is movable inward in the direction of the center of the wheel and outward opposing the center of the wheel.

Body 101 is also positioned at least partially inside the inner space of the tire, so an outward side of the piston is exposed to the air inside the tire.

Reference is now made to FIG. 2, which is a cross section illustration of a self-inflation device 100, positioned on a rim 200 of a wheel, according to some embodiments of the present invention. Rim 200 is optionally adapted to include self-inflation device 100, or may include a mount to fixate body 101. Body 101 may be positioned partially within an outer space of a tire 210, in a central part of the wheel.

Body 101 also includes an intake opening 104, which is external to an inner space of the tire, allowing air from outside the tire to flow into piston compartment 102. Intake opening 104 may be located in a part of body 101 which is external to an inner space of the tire, or may include an extension, for example a tube, which has one end external to an inner space of the tire. Optionally, a second intake opening is included in body 101, for example located in an opposing side of piston compartment 102 to intake opening 104. Optionally, a plurality of intake openings is included in body 101, for example arranged in a ring around the perimeter of piston compartment 102.

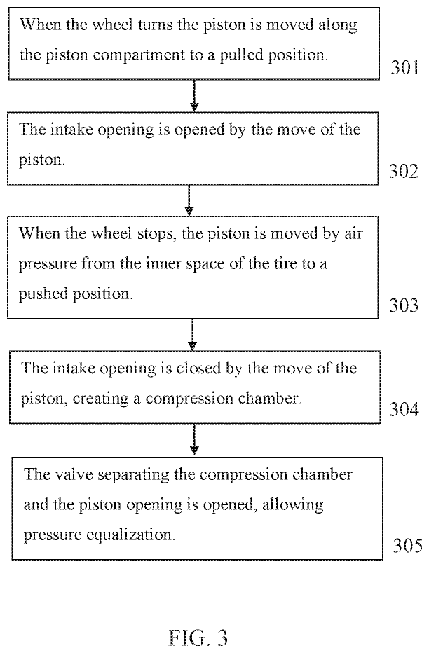

Reference is now made to FIG. 3, which is a flowchart schematically representing a method for maintaining pressure in a tire by a self-inflation device, according to some embodiments of the present invention.

First, as shown at 301, when the wheel turns at a high speed, piston 103 is moved along piston compartment 102 to a pulled position, by centrifugal force applied by the rotation of the wheel. The speed needed for the centrifugal force to move piston 103 is determined by the design of self-inflation device 100, and specifically by the weight of piston 103 and pressure applied on piston 103 by the air inside the tire.

Then, as shown at 302, intake opening 104 is opened by the move of piston 103, which allows air from outside the tire to flow into piston compartment 102.

Optionally, piston 103 includes a sealing component 105 which is positioned around piston 103 and pressed into piston compartment 102. Sealing component 105 may be, for example, a rubber seal ring, a synthetic rubber seal ring such as an O-ring or any other seal ring or washer. Optionally, sealing component 105 is a U-Cup seal, such as used in the pneumatic and hydraulic industries because of low breakaway force and dynamic friction. When sealing component 105 moves beyond intake opening 104, intake opening 104 is opened.

Then, as shown at 303, when the wheel slows or stops turning, piston 103 is moved to a pushed position by air pressure from the inner space of the tire. In this state centrifugal force is no longer applied. The speed in which this happens is determined by the design of self-inflation device 100, as described above.

Then, as shown at 304, intake opening 104 is closed by the move of piston 103, which prevents air from escaping outside and creates a compression chamber 106 within piston compartment 102. The surface of piston 103 which is exposed to the inner space of the tire is larger than the surface exposed to the chamber, so a larger force is applied on piston 103 by the air inside the tire, moving piston 103 further to compression chamber 106 and increasing air pressure inside compression chamber 106.

Piston 103 includes a piston opening 107, which is internal to the inner space of the tire. Optionally, piston opening 107 is a channel passing along piston 103.

Then, as shown at 305, a valve 108 separating compression chamber 106 and piston opening 107 is opened, allowing airflow and pressure equalization between compression chamber 106 and the inner space of the tire. The air may flow from compression chamber 106 to the tire, from the tire to compression chamber 106 or none at all, depending on the pressures inside compression chamber 106 and the inner space of the tire, as described above.

Valve 108 may be located on the tip of piston 103, at the end of piston opening 107. Optionally, valve 108 is a standard pneumatic valve stem core commonly used on automobile and/or bicycle wheels, such as a Schrader valve. Valve 108 may also be any other pneumatic valve, for example including a poppet valve.

Optionally, valve 108 is pressed by a pin 109 located in an opposing side of compression chamber 106 to valve 108. Pin 109 may be a part of body 101, or may be included in separate component. When piston 103, with valve 108, moves toward pin 109, valve 108 is pressed onto pin 109 and opens, as shown at FIG. 1B.

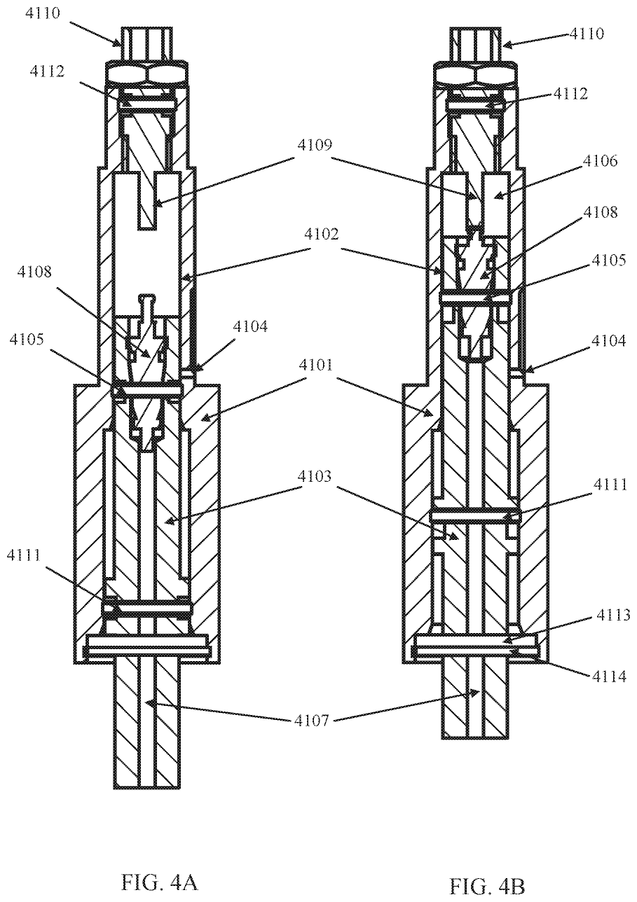

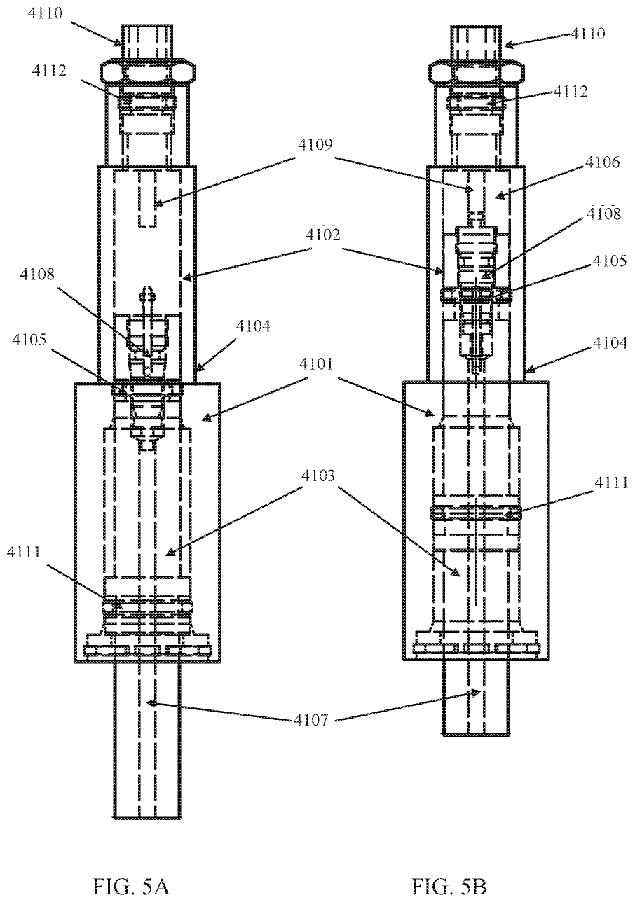

Optionally, size of compression chamber 106 and/or the pressure in compression chamber 106 when valve 108 is opened, are adjusted by an adjustment mechanism. Reference is now made to FIGS. 4A and 4B, which are cross section illustrations of a self-inflation device having an adjustment mechanism, with a piston in a pulled position and in a pushed position, respectively, according to some embodiments of the present invention. Reference is also made to FIGS. 5A and 5B, which are further schematic illustrations of the self-inflation device of FIGS. 4A and 4B, respectively, according to some embodiments of the present invention. The self-inflation device of FIGS. 4A, 4B, 5A, and 5B is similar to that of the preceding Figures, and accordingly similar elements are assigned similar reference numbers, except that the numbers begin with 4100 instead of 100. Optionally, the adjustment mechanism includes a screw 4110 that is attached to body 4101, and moves pin 4109 and/or a component holding pin 4109. Screw 4110 may be located on the end of body 4101 opposing piston 4103, sealing piston compartment 4102. When screw 4110 is adjusted, the size of compression chamber 4106 may be changed, so a different amount of air may be captured in compression chamber 4106. Also, when screw 4110 is adjusted, pin 4109 may be moved closer or further to valve 4108, so pin 4109 is pressed to valve 4108 at a different location, and therefore when the air in compression chamber 4106 is at a different pressure.

Optionally, the adjustment mechanism includes a switch which changes the pressure in compression chamber 4106 between two or more discrete pressures. This is advantageous when different pressures are required in the tire in different situations, for example with different load of the vehicle.

Optionally, self-inflation device 4100 includes other components for adjustment, for example a balancing weight attached to piston 4103 to increase centrifugal force.

Optionally, piston 4103 includes an additional sealing component 4111, to further prevent air from passing between piston 4103 and piston compartment 4102, as described above for sealing component 4105. Optionally, screw 4110, pin 4109 and/or a component holding pin 4109 includes a sealing component 4112. Self-inflation device 4100 may further include any other sealing components.

Optionally, piston 4103 is prevented from being pulled from piston compartment 4102 by the centrifugal force, for example by a shim ring 4113, optionally held by a spring retaining ring 4114.

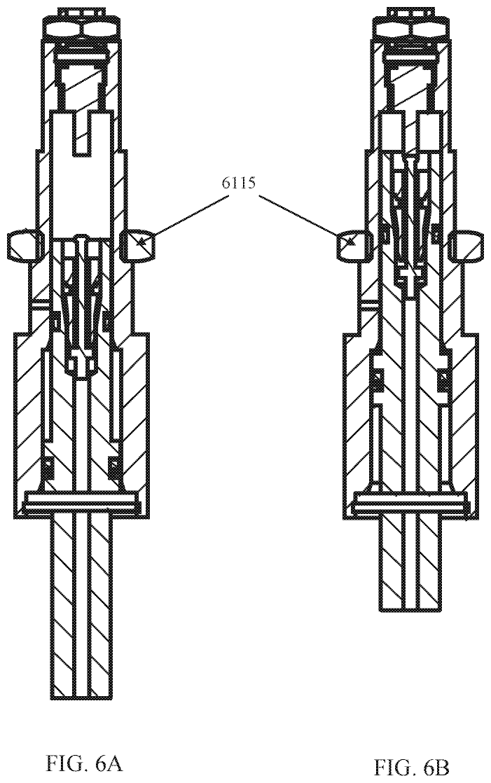

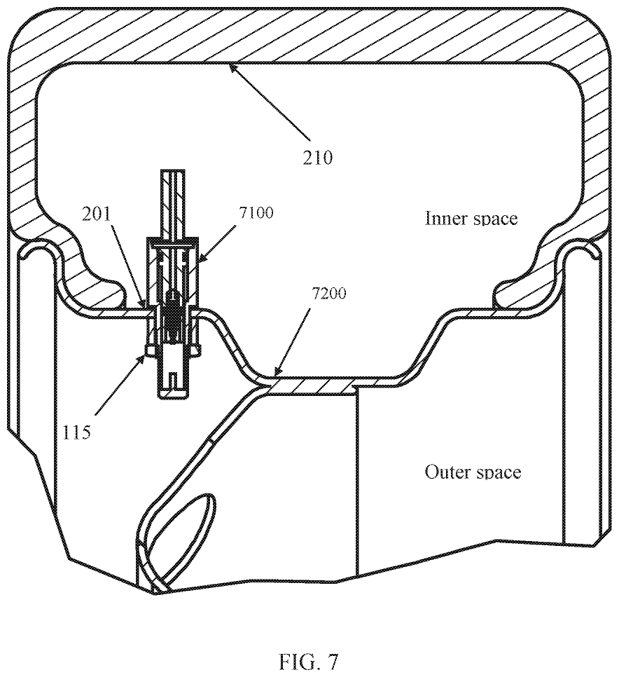

Optionally, a mount adapted to fixate body 101 in relation to the tire is included. Reference is now made to FIGS. 6A and 6B, which are cross section illustrations of a self-inflation device 6100 having a mount 6115, with a piston in a pulled position and in a pushed position, respectively, according to some embodiments of the present invention. The self-inflation device of FIGS. 6A and 6B is similar to that of the preceding Figures, and accordingly similar elements are assigned similar reference numbers, except that the numbers begin with 6100 instead of 100. Reference is also made to FIG. 7, which is a cross section illustration of a self-inflation device 7100, positioned on rim 7200 of a wheel by a mount 7115, according to some embodiments of the present invention. Spacers and/or washers may be used to adjust the position of the device in the rim, for example as shown at 201. The self-inflation device of FIG. 7 is similar to that of the preceding Figures, and accordingly similar elements are assigned similar reference numbers, except that the numbers begin with 7100 instead of 100.

Optionally, self-inflation device 7100 includes a tire valve portion 120, which includes a one way inflation channel and may be positioned at a tire valve opening of the tire.

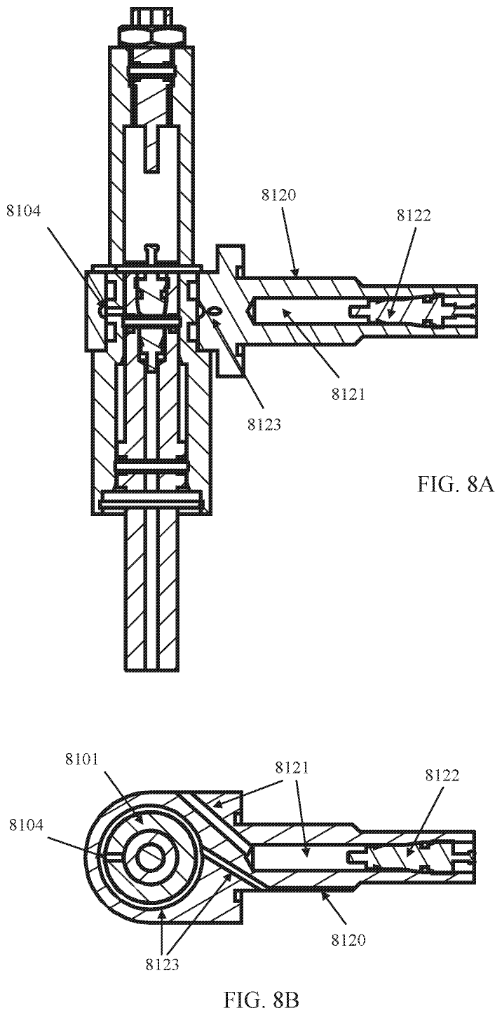

Reference is now made to FIGS. 8A and 8B, which are different cross section illustrations of a self-inflation device 8100 having a tire valve portion, according to some embodiments of the present invention. The self-inflation device of FIGS. 8A and 8B is similar to that of the previous figures, and accordingly similar elements are assigned similar reference numbers, except that the numbers begin with 8100 instead of 100.

Tire valve portion 8120 is connected to body 8101 and includes a one-way inflation channel 8121. One-way inflation channel 8121 may include an inflation valve 8122 which may be a standard pneumatic valve stem. Tire valve portion 8120 also includes an intake channel 8123 attached to intake opening 8104.

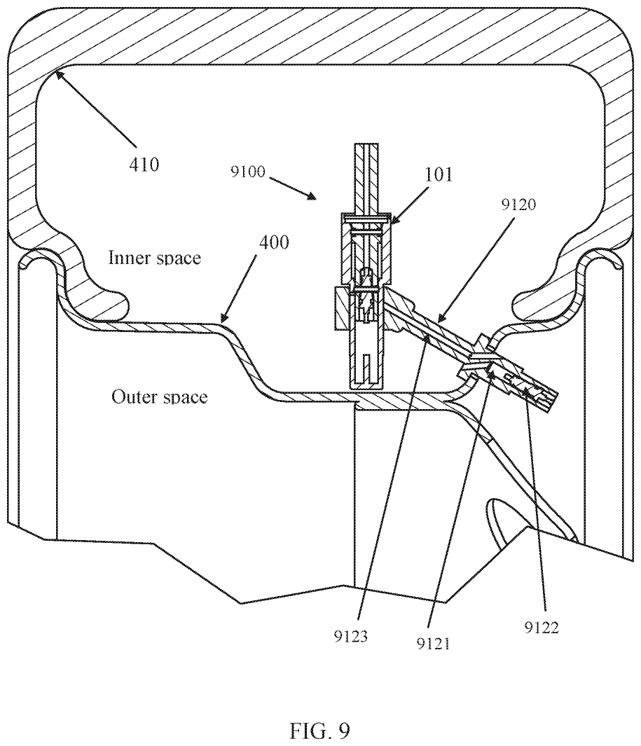

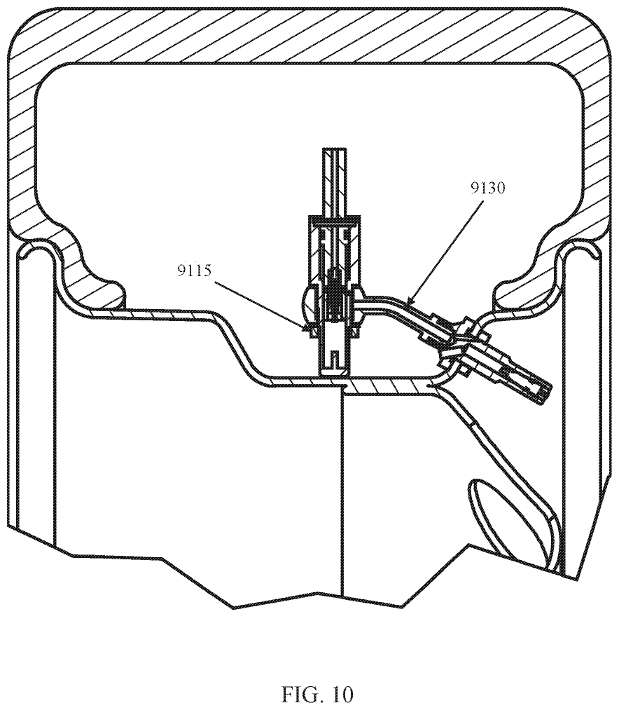

Reference is now made to FIG. 9, which is a cross section illustration of a self-inflation device 9100 having a tire valve portion positioned at a tire valve opening in a rim 400 of a wheel having holding a tire 410, according to some embodiments of the present invention. The self-inflation device of FIGS. 9 and 10 is similar to that of the previous figures, and accordingly similar elements are assigned similar reference numbers, except that the numbers begin with 9100 instead of 100. Reference is also made to FIG. 10, which is a cross section illustration of a self-inflation device having a tire valve portion 9130 held by mount 9115, positioned at a tire valve opening in a rim 400 of a wheel, according to some embodiments of the present invention.

Valve portion 9120 is positioned at least partially outside the inner space of the tire, so an outward side of inflation valve 9122 is exposed to the air outside the tire. Channel 9121 then connects between the inner space of the tire and the outside air, separated by valve 9122. Inflation valve 9122 may then be used as a regular tire valve.

Channel 9123 connects between intake opening 9104 and the air outside the tire, allowing air to flow inside piston compartment 9102 when piston 9103 is in pulled position.

Optionally, a plurality of self-inflation devices is used in one tire, to further increase inflation.

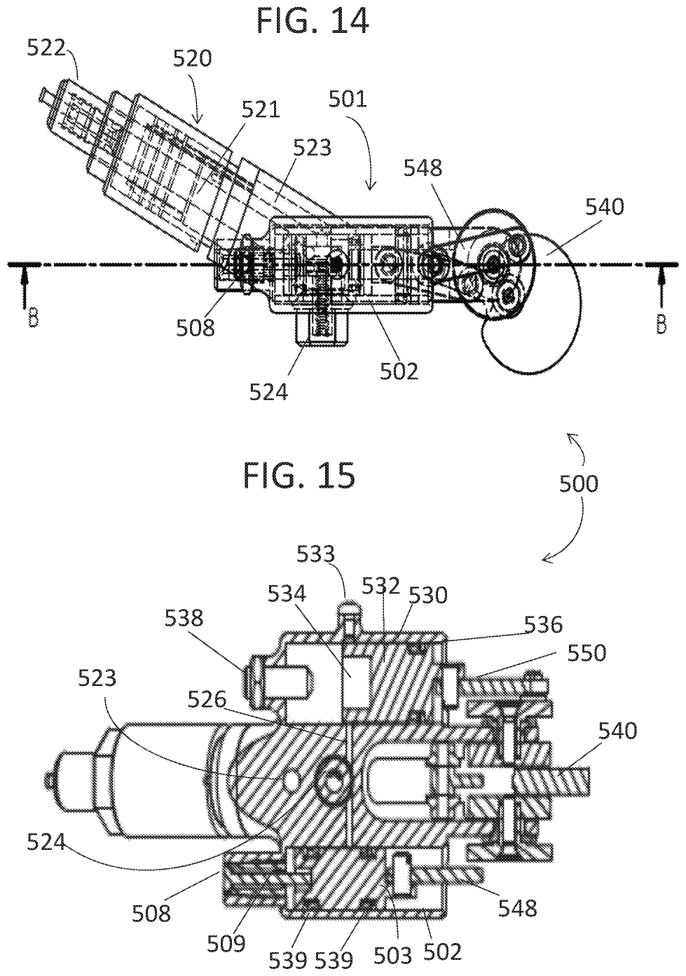

FIGS. 11-24 depict additional embodiments of self-inflation devices, according to some embodiments of the invention. The embodiments of FIGS. 11-24 are similar in certain respects with embodiments depicted in the previous figures, and accordingly similar elements are assigned similar reference numbers, except that the numbers begin with 500 instead of 100.

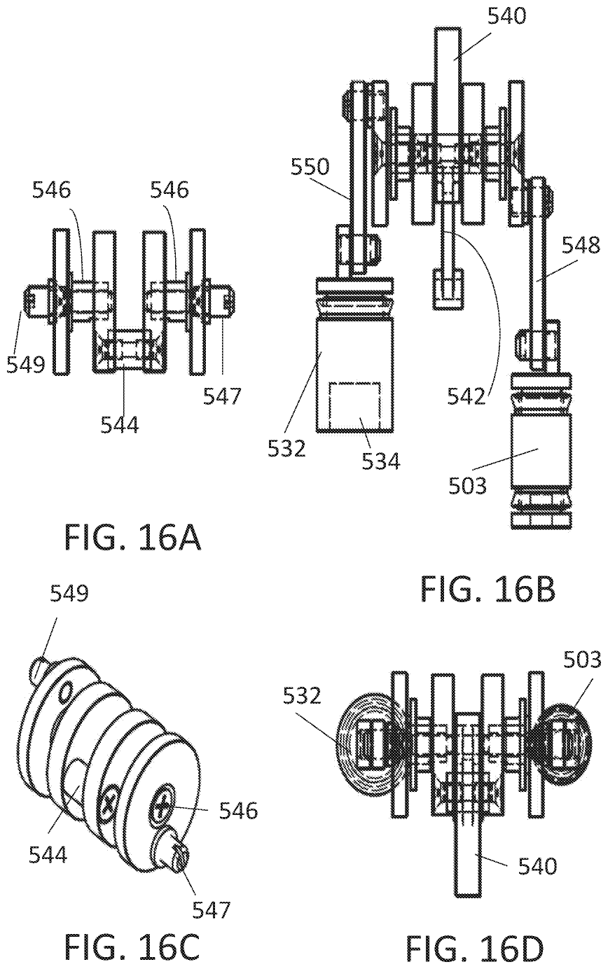

Referring to FIGS. 11-16D, and in particular to FIG. 11, self-inflation device 500 is comprised of body section 501 and air intake section 520. Body section 501 is oriented along axis X and includes piston compartment 502 and sub-pressure compartment 530. As used herein, “shaft axis” refers to axis X. Piston compartment 502 and sub-pressure compartment 530 are cylindrical tubes arranged at least approximately symmetrically around channel 552. Sub-pressure compartment 530 has a larger diameter than piston compartment 502. The difference in diameters of sub-pressure compartment 530 and piston compartment 502 can also be seen in FIG. 16D, which is a rear view of the device 500. Sub-pressure compartment 530 also includes screw 538, which is rotatable to adjust the volume of the interior of sub-pressure compartment 530.

Connecting rod 548 extends from piston compartment 502, and connecting rod 550 extends from sub-pressure compartment 530. Connecting rod 548 and connecting rod 550 are joined by crankshaft 546. Crankshaft 546 may be any suitable structure or combination of structures, for example, a pin or a bolt. In the depicted embodiments, and as seen best in FIGS. 16A and 16C, crankshaft 546 includes two co-linear bolts arranged on an axis between connecting rod 548 and connecting rod 550.

Weight 540 is configured in the middle of crankshaft 546, equidistant between connecting rod 548 and connecting rod 550. Weight 540 is held in place by weight pin 544 (shown in FIGS. 13, 16A, and 16C). Weight 540 defines a center of mass C. Weight 540 is attached to crankshaft 546 off-center, so that the center of mass C is located outside the axis of the crankshaft 546. In the configuration of FIG. 11, center of mass C is below the plane defined by the crankshaft and axis X. Weight 540 functions as a crank for rotating crankshaft 546, as will be discussed below.

Weight 540 also includes arm 542. Arm 542 is slidably configured within groove 552 of body 501. When weight 540 rotates crankshaft 546, arm 542 prevents the weight 540 from turning on its axis. At the end of arm 542, there is a pivot that slides inside the groove 552, to prevent the weight 540 from turning.

Air intake section 520 is attached to body section 501 at an end opposite crankshaft 546. Air intake section 520 includes tire valve 522 for inflating the tire. Tire valve 522 may be a standard pneumatic valve stem. Air intake section 520 also includes intake opening 504 (not shown in FIG. 11) for delivering air to the sub-pressure compartment 530 and piston compartment 502. The mechanism of delivery of air to the piston compartment 502 through intake opening 504 will be discussed in greater detail below.

Air intake section 520 also includes locking nut 528. Locking nut 528 may secure self-inflation device 500 onto a tire. In the secured position, the locking nut 528, tire valve 522, and intake opening 504 are located on the exterior of the tire and exposed to ambient atmosphere, while body 501 is located in the interior of the tire.

As can be seen in FIG. 11, body 501 and air intake section 520 are situated at an angle relative to each other. The angle between shaft axis X and the air intake section may be any angle between 0 and 90 degrees. The degree of this angle may be set as needed, for example, in order to fit the self-inflation device 500 into a tire, or in order to calibrate the self-inflation device 500 to inflate the tire at a particular air pressure. For example, a different angle will be required for a tire for a truck compared to a tire for an automobile.

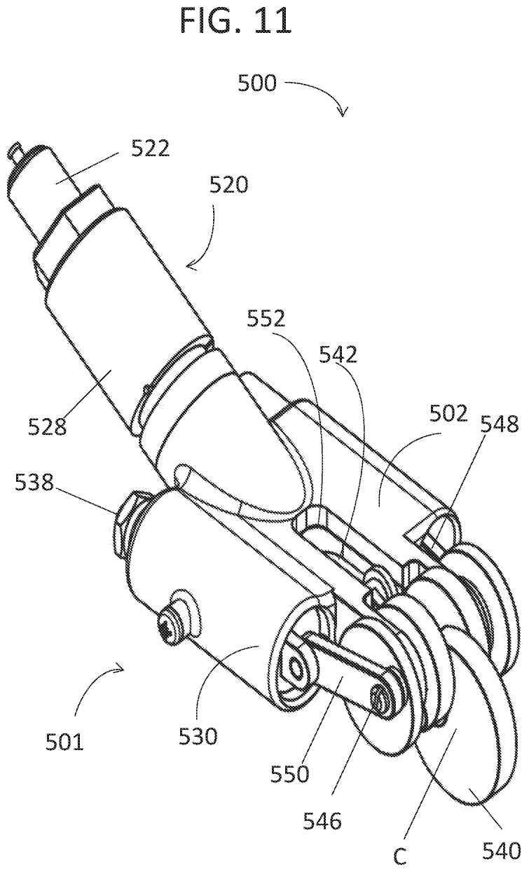

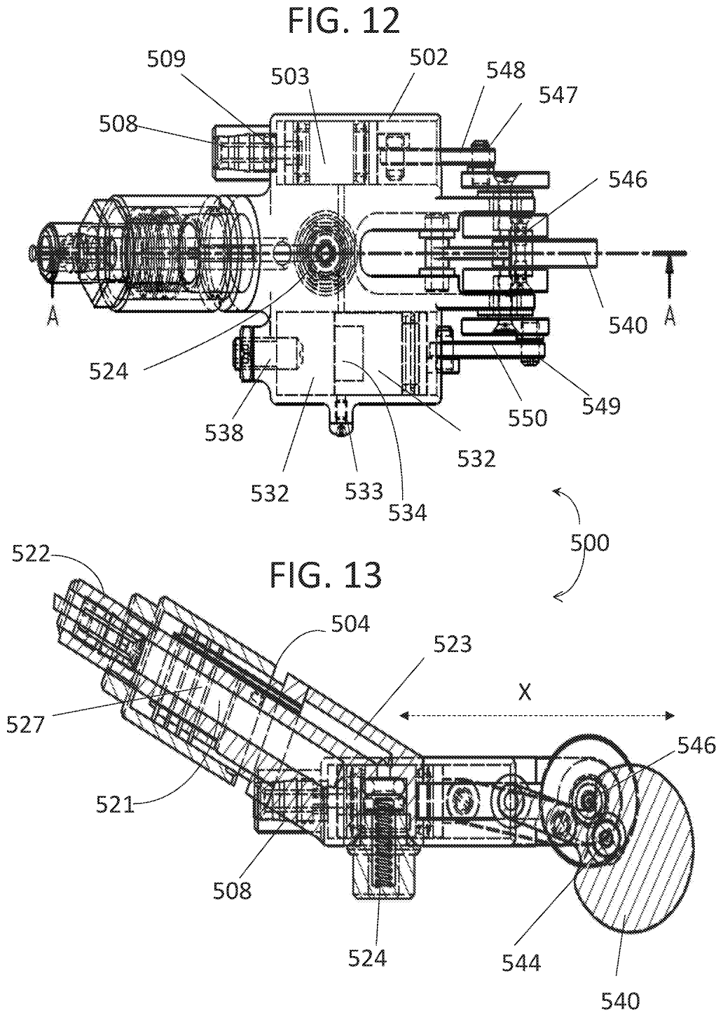

FIGS. 12-15 and 16A-D show additional views of the self-inflation device 500, which depict various internal structures.

As seen best in FIGS. 12, 15, and 16B and D, sub-pressure compartment 530 includes plunger 532. Plunger 532 is mechanically connected to connecting rod 550, for example, with a screw or pin. Correspondingly, piston compartment 502 includes piston 503, which is mechanically connected to connecting rod 548. Shafts 548 and 550 are attached to crankshaft 546 to at opposing rotational positions. FIGS. 16A and 16C depict the crankshaft 546 with connecting pins 547, 549 for connecting rods 548, 550. In the position depicted in FIGS. 12-15, connecting rod 548 is extended, and connecting rod 550 is retracted. As used in this application, the term “extended” or “posterior” refers to a direction further from crankshaft 546, and the term “retracted” or “anterior” refers to a direction closer to crankshaft 546. Rotation of the crankshaft 546, for example, by rotation of the weight 540 attached thereto, thus causes simultaneous reciprocating motion in connecting rod 548 and connecting rod 550.

As seen best in FIGS. 12, 15, and 16B, plunger 532 includes a hollow portion 534. The depth of hollow portion 534 is adjustable to calibrate the volume of air that may be filled into sub-pressure compartment 530 when the plunger is in its retracted position. That is, when the volume of hollow portion 534 is increased, more air may be filled into the sub-pressure compartment. In addition, the larger the volume of the hollow portion 534, the lower the maximum pressure that may be reached in the sub-pressure compartment 530. The volume and maximum pressure of the sub-pressure compartment 530 may also be adjusted through rotation of screw 538, as previously discussed. That is, changing the length of screw 538 within the sub-pressure compartment 530 causes a change of volume in the sub-pressure compartment 530. As the volume in sub-pressure compartment is decreased, the maximum pressure is increased.

Sub-pressure compartment 530 also includes access hole 533, which is depicted as closed in an airtight fashion. Access hole 533 may be used for drilling one or more inner holes or channels in body 501.

In the depicted embodiments, and as seen best in FIG. 13, air intake section 520 includes two channels 521, 523. Intake channel 521 is a one-way inflation channel that directs air from inflation valve 522 into the interior of the tire. Optionally, air filter 527 filters air incoming through valve 522. Intake channel 523, which may be configured parallel to intake channel 521, receives incoming air from intake opening 504. Intake channel 523 directs air from intake opening 504 to safety valve 535. Safety valve 535 is a one-way valve that permits air to enter therethrough, and prevents loss of air backward through intake channel 523. From safety valve 535, air enters sub-pressure compartment 530 through interior air channel 526.

Air also exits sub-pressure compartment 530 through interior air channel 526. Interior air channel 526 provides a fluidic connection between sub-pressure compartment 530 and piston compartment 502.

Plunger 532 also includes a sealing component 536. In the depicted embodiments, sealing component 536 is an O-ring. Sealing component 536 is positioned around plunger 532 and is pressed into the sub-pressure compartment 530. Sealing component 536 prevents air from escaping sub-pressure compartment 530 from behind plunger 532.

There is no corresponding sealing component between the plunger 532 and interior air channel 526. Thus, when plunger 532 is retracted, interior air channel 526 and sub-pressure compartment 530 define a relatively large volume in which air can collect. When plunger 532 is extended, the volume of sub-pressure compartment 530 is reduced, and air is pressurized within sub-pressure compartment 530 and/or expelled into interior air channel 526.

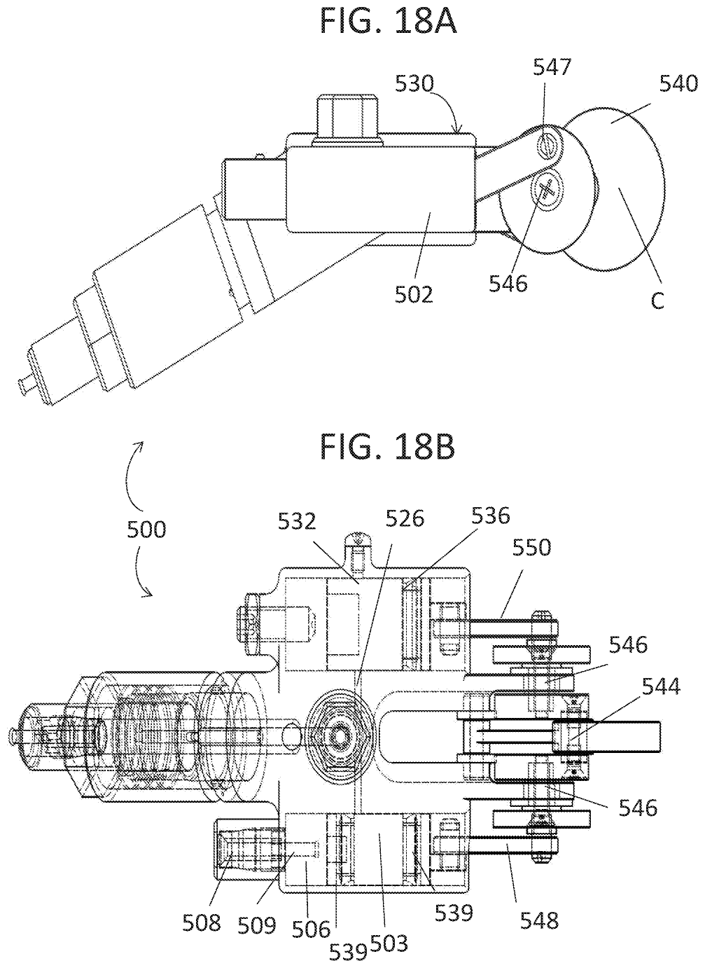

Piston 503 also includes at least one sealing component 539. In the depicted embodiments, sealing component 539 is a pair of O-rings. The anterior O-ring 539 prevents air from escaping piston compartment 502 from behind piston 503. When piston 503 is retracted, the posterior O-ring is retracted relative to interior air channel 526, and air can freely exchange between piston compartment 502 and interior air channel 526. When sealing component 539 is extended posterior to interior air channel 526, air cannot exchange between interior air channel 526 and piston compartment 502. In such a configuration, air is pressurized within piston compartment 502 to form therein a compression chamber 506 (as shown, for example, in FIG. 18B).

Valve 508 is located at the anterior end of piston compartment 502. Optionally, valve 508 is a standard pneumatic valve stem core commonly used on automobile and/or bicycle wheels, such as a Schrader valve. Valve 508 may also be any other pneumatic valve, for example, a poppet valve. Optionally, valve 508 is configured to be pressed by a pin 509 located in piston compartment 502. Pin 509 may be a part of piston 503, or may be included as a separate component, as shown. As shown in FIG. 15, when piston 503 engages pin 509, pin 509 is pressed onto valve 508 and opens the valve 508.

The valve opening pressure may be correlated with the pressure inside the compression chamber 506 and the desired pressure for the interior of the tire. For example, if the desired pressure within the tire is 34 pounds per square inch (psi), and the pressure achieved in the compression chamber is 40 psi, then the valve 508 may be configured to open only when the pressure differential across the valve 508 exceeds 6 psi. Similarly, the maximum pressure that is achievable within the compression chamber may be adjusted, for example, with screw 538. In this way, the valve 508 is prevented from overfilling the tire.

In one exemplary embodiment, body 501 is approximately 53 mm long, as measured along the shaft axis from the crankshaft to the end of the valve. Air intake section is approximately 55 mm long, as measured from the end of valve 522 to safety valve 524. The diameter of valve 522 may be approximately 8 mm, and the diameter of the air intake section, including locking nut 528, may be approximately 15 mm. The provided dimensions are for illustration only, and are not to be treated as limiting in any way, as would be understood by one of skill in the art.

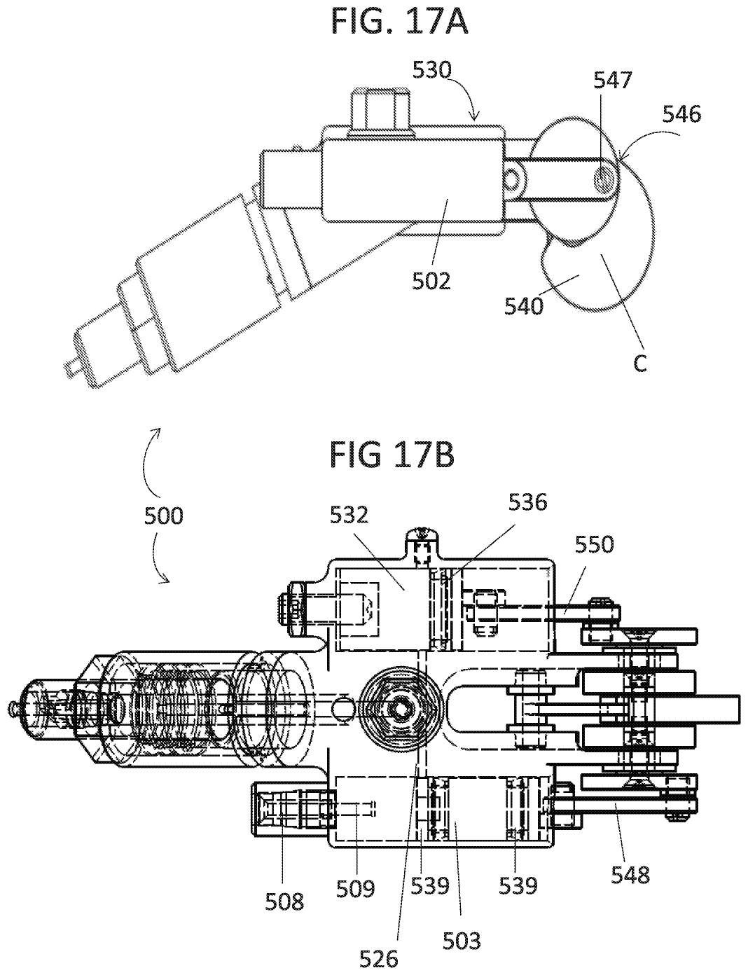

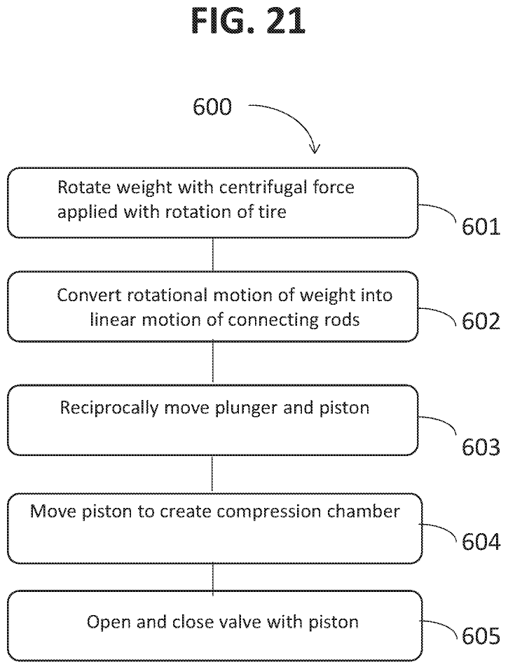

FIGS. 17A-20B depict self-inflation device 500 in a rest position and three rotation positions when it is used to inflate a tire. FIG. 21 depicts a method 600 of inflating a tire using self-inflation device 500.

Referring to FIGS. 17A and 17B, when self-inflation device 500 is in a rest position, connecting rod 550 is extended, and connecting rod 548 is retracted. Self-inflation device 500 assumes this position when it is at rest because of the action of the internal tire pressure on the plunger 532 and the piston 503. Specifically, due to the larger diameter of the plunger 532 compared to the piston 503, the internal tire pressure of the tire exerts greater force on the plunger 532 than on the piston 530. Due to this increased pressure, connecting rod 550 is pushed to an extended position and connecting rod 548 is retracted.

In the rest position of FIGS. 17A and 17B, sub-pressure compartment 530 is fully closed. Air that had previously entered sub-pressure compartment 530 (i.e., through interior air channel 526) is pushed through the interior air channel 526 by the closure of the sub-pressure compartment. The piston compartment 502 is fully open, because sealing component 539 is anterior to interior air channel 526. The air inside piston compartment 502 may thus be at or slightly above atmospheric pressure.

In addition, in the rest position of FIGS. 17A and 17B, center of mass C of the weight 540 is below the crankshaft 546. Weight 540 is attached to crankshaft 546 in such a configuration that, when connecting rod 550 is in an extended position and connecting rod 548 is in a retracted position, the center of mass C is below crankshaft 546.

In accordance with basic principles of physics, the moment of inertia I for rotation of the crankshaft 546 by weight 540 is given by the equation

I=m*r²

where m denotes the mass of the weight, and r denotes the perpendicular distance between center of mass C and the crankshaft 546. The amount of torque T required to rotate crankshaft 546 with weight 540 is given by the equation

T=I*a

where I denotes the moment of inertia and a denotes the angular acceleration of the weight 540. Because weight 540 is affixed off-center to crankshaft 546, the radial distance between the center of mass C and crankshaft 546 varies as the weight 540 rotates. Correspondingly, the amount of torque T required to rotate the weight varies according to the square of the radial distance. Because the crankshaft 546 rotates with weight 540, the torque that is applied to rotate the weight is translated onto the crankshaft 546.

Turning now to method step 601, a user begins to rotate the tire, for example, by driving a vehicle on which the tire is located. Rotation of the tire causes application of centrifugal force on the tire and on the self-inflation device 500 which is attached thereto. The centrifugal force causes the tire to expand radially outward, along with the self-inflation device 500, and also causes the weight 540 to rotate radially upward and in an anterior direction relative to crankshaft 546. The weight 540 then reaches the first rotation position of FIGS. 17A and 17B.

As shown in method step 602, due to the positioning of connecting rods 548 and 550 on crankshaft 546, rotation of crankshaft 546 converts the rotational motion of the weight 540 to linear motion of shafts 548 and 550. In addition, as indicated in method step 603, because plunger 532 is mechanically connected to connecting rod 550, and piston 503 is mechanically connected to connecting rod 548, the rotational motion of the weight 540 causes reciprocal motion of the plunger 532 and the piston 540.

During movement of self-inflation device 500 from the rest position to the first rotation position, plunger 532 is retracted into an open position, allowing a larger volume of air to enter the sub-pressure compartment 530 from interior air channel 526. Conversely, the piston 503 is extended, such that sealing component 539 blocks air from the interior air channel 526 from entering piston compartment 502. As a result, and as indicated in method step 604, compression chamber 506 is formed within piston compartment 502.

When weight 540 is in the first rotation position of FIGS. 18A and B, center of mass C is further from the crankshaft 546 than it is at any other point in its rotation cycle. As a result, a comparatively high torque will be required to induce further rotation of the weight 540. As can be recognized by those of skill in the art, the dimensions of the weight 540, the mass of the weight C, and the specific configuration of the center of mass C in relation to crankshaft 546, may be designed to require a certain minimum torque in order to rotate the weight 540 entirely around the crankshaft 546. The degree of this torque can vary according to particular design considerations for each self-inflation device 500, for example, whether it is configured in a car or in a truck.

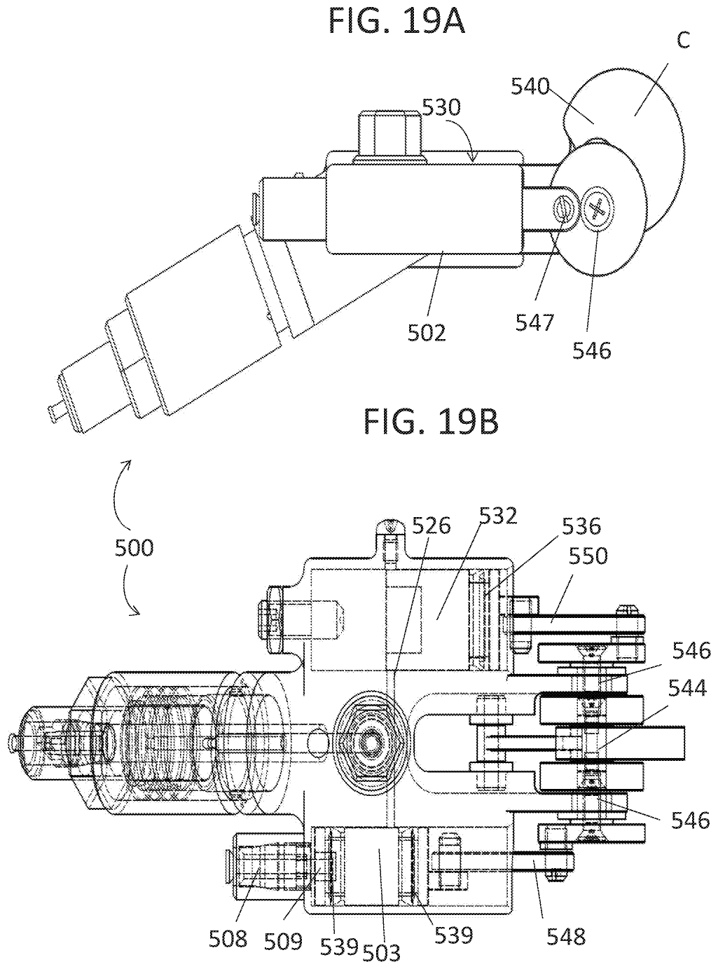

When the torque on the weight 540 is sufficiently high, the weight 540 will move from the first rotation position of FIGS. 18A-B to the second rotation position of FIGS. 19A and B. During this movement of the weight 540, the rotational movement of the weight is translated into linear movement of the piston and plunger, piston 503 is correspondingly extended, and plunger 532 is correspondingly retracted. In the second rotation position, and as shown in step 605, piston 503 is sufficiently extended that it engages pin 509 and pushes it into valve 508, thereby opening the valve 508. When the pin 509 opens valve 508, the air in compression chamber 506 moves into the tire. Simultaneously, in the sub-pressure compartment 530, the retraction of plunger 532 causes sub-pressure compartment 530 to be completely opened, allowing air to entirely fill sub-pressure compartment 530.

In the second rotation position of FIGS. 19A and 19B, the center of mass C of weight 540 is closer to the crankshaft 546 than in the first rotation position of FIGS. 18A and 18B. Accordingly, the torque required to rotate the weight is likewise lower.

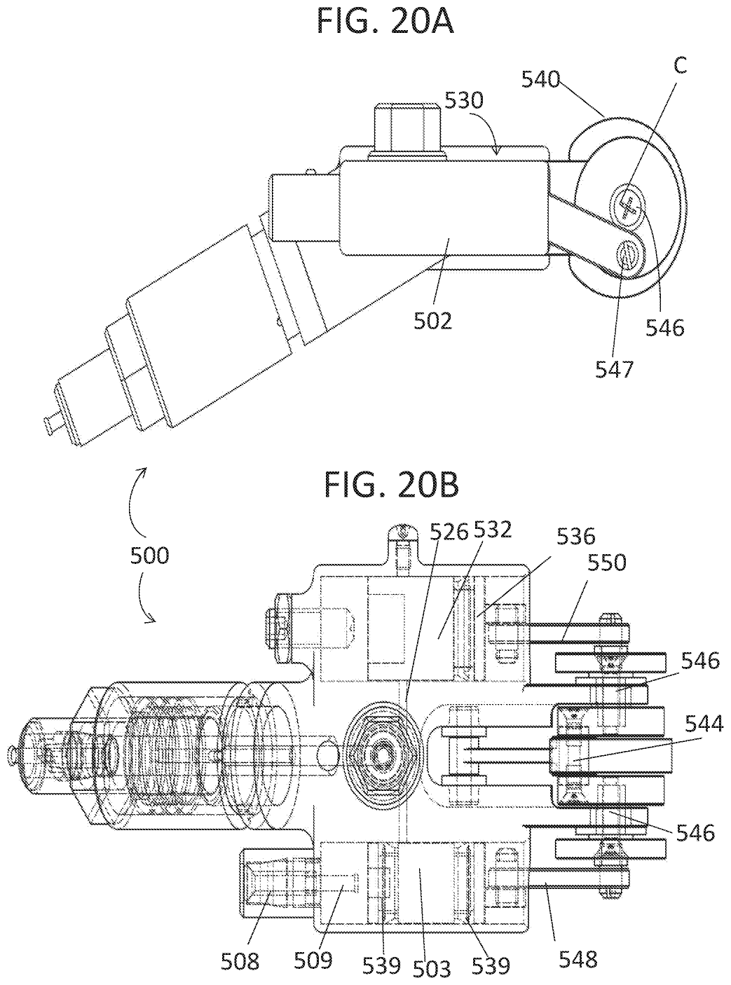

Further application of centrifugal force moves the weight 540 into the third rotation position of FIGS. 20A and 20B. In the third rotation position, plunger 532 is partially extended in a posterior direction. This extension, in turn, causes partial closure of the sub-pressure compartment 530 and partial compression of the air in the sub-pressure compartment 530. Correspondingly, piston 503 is partially retracted, creating a vacuum in piston compartment 502. In this position, plunger 532 and piston 503 are extended the same distance relative to crankshaft 546.

In the third rotation position of FIGS. 20A and 20B, the center of mass of the weight 540 is within the axis of crankshaft 546. The torque required to rotate the weight 540 is thus at its lowest point in the cycle. From this position, the internal pressure in the tire suffices to push plunger 532 forward and to reciprocally retract piston 503. The self-inflation device 500 then returns to the rest position of FIGS. 17A and 17B.

The path of air from the ambient atmosphere to the tire, when the device cycles between each of the rest and rotation positions, is as follows. At all times, air may enter device 500 through air intake opening 504, proceeds through intake channel 523, and enter safety valve 524. Safety valve 524, as discussed, is a one-way valve that prevents any backflow of air. Air passing through safety valve 524 then enters interior air channel 526.

When device 500 has just discharged air into the tire (for example, in the second rotation position of FIGS. 19A-B), interior air channel 526 is open to sub-pressure compartment 530 and closed to piston compartment 502. Accordingly, all incoming air proceeds to sub-pressure compartment 530. When self-inflation device 500 is then rotated to the third rotation position of FIGS. 20A-B, the volume in the sub-pressure chamber is reduced due to the extension of plunger 532. Air is thus compressed within sub-pressure chamber 530 and interior air channel 526. Simultaneously, a vacuum is formed within piston compartment 502, because it is still sealed from interior air channel 526 by sealing component 539.

When the self-inflation device 500 is then restored to the rest position, the volume of the sub-pressure compartment is reduced to nearly zero, because of the extension of the plunger 532. Nearly all of the collected air proceeds through interior air channel 526 and into piston compartment 502. Then, when the device 500 is moved to the first rotation position, the air in the piston compartment 502 is compressed in the compression chamber 506. When the device 500 reaches the second rotation position, this air is injected into the tire. Simultaneously, the sub-pressure compartment 530 is open, and a new volume of air begins to enter the sub-pressure compartment 530 through interior air channel 526.

Advantageously, the self-inflation device 500 depicted in FIGS. 17A-20B and the method described in FIG. 21 may be used to refill air in a tire while the tire is rotating. Another advantage of the depicted embodiments is that the self-inflation device 500 can repeat the same cycle numerous times while a tire is rotating, thus permitting a larger quantity of air to refill the tire. Another advantage of the depicted embodiments is that the self-inflation device 500 refills the tire without requiring any external pump or source of pressure.

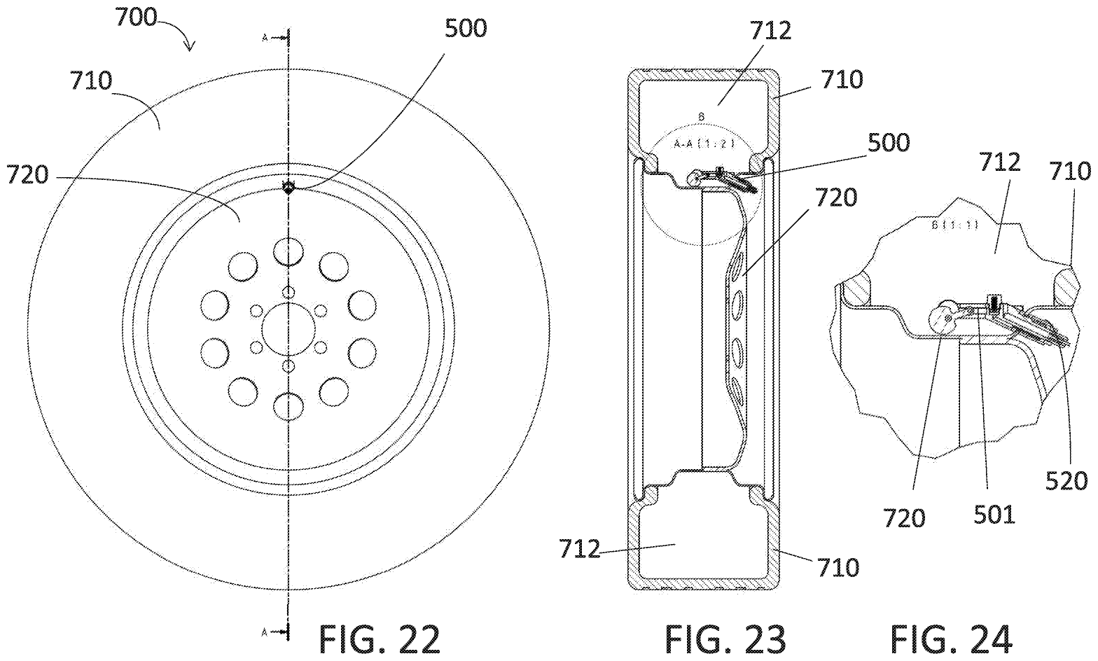

Reference is now made to FIGS. 22-24, which depict self-inflation device 500 mounted in a wheel 700, according to some embodiments of the invention. As shown in FIG. 22, wheel 700 includes tire 710 and rim 720. Self-inflation device 500 is mounted in the wheel 700 in the same approximate location as a standard tire valve. FIG. 23 is a cross-section view of the wheel 700 with self-inflation device 500, and FIG. 24 is a close-up view of the circled section of FIG. 23. Body section 501 is configured within inner space 712 of tire 710, and air intake section 520 is configured outside the tire 710. In this configuration, self-inflation device 500 can also be used as a regular tire valve.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant self-inflation devices will be developed and the scope of the term self-inflation device is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method. As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A self-inflation device for maintaining pressure in a tire, comprising:
a piston compartment,
a piston housed in the piston compartment,
an intake opening configured to be external to an inner space of the tire when the self-inflation device is installed in an operational position, the intake opening configured for fluidically connecting the piston compartment to ambient atmosphere external to the inner space, and
a valve for controlling airflow between the piston compartment and the inner space of the tire, wherein airflow between the piston compartment and the inner space is allowed when the valve is opened and prevented when the valve is closed;
wherein the piston is movable within the piston compartment between
an air intake position in which the intake opening fluidically connects the piston compartment and the ambient atmosphere, and
a compression position, in which the piston fluidically seals the piston compartment from the intake opening, thereby creating a compression chamber; and
wherein, when the self-inflation device is installed in the operational position, the piston opens and closes the valve, and cycles between the air intake and the compression positions, through application of centrifugal force onto the self-inflation device by rotation of the tire.

2. The self-inflation device of claim 1, further comprising a pin located in the piston compartment and configured to press the valve when the piston is in the compression position, to thereby open the valve.

3. The self-inflation device of claim 1, further comprising:
a body, wherein the piston compartment is configured on one side of the body;
a sub-pressure compartment configured on an opposing side of the body relative to the piston compartment, and including a plunger slidably configured therein, wherein the plunger is movable within the sub-pressure compartment between an open position, in which air fills into the sub-pressure compartment via the air intake opening, and a closed position, in which the plunger compresses the air within the sub-pressure compartment;
and an interior air channel within the body for fluidically connecting between the sub-pressure compartment and the piston compartment;
wherein, in the air intake position, the piston compartment is configured to receive air from the sub-pressure compartment via the interior air channel.

4. The self-inflation device of claim 3, wherein the sub-pressure compartment has a larger diameter than the piston compartment.

5. The self-inflation device of claim 3, wherein the plunger is at least partially hollow.

6. The self-inflation device of claim 1, further comprising:
a first connecting rod extending laterally from the piston along a shaft axis;
a second connecting rod extending laterally from the plunger along the shaft axis;
a crankshaft configured perpendicular to the first and second connecting rods and extending therebetween;
and a weight attached to the crankshaft between the first and second connecting rods, such that rotation of the weight causes corresponding reciprocal movement of the first and second connecting rods;
wherein the first and second connecting rods respectively define retracted positions and extended positions;
wherein the first connecting rod and second connecting rod are attached to the crankshaft at rotationally opposite positions, such that when one of the first and second connecting rod is in its retracted position, the other is in its extended position, and vice versa.

7. The self-inflation device of claim 6, wherein, when the self-inflation device is installed in the operational position and when the wheel is at rest, a center of mass of the weight is below the shaft axis, the second connecting rod is in its extended position causing the plunger to reduce the volume of the sub-pressure compartment, and the piston is in a retracted position permitting airflow between the interior air channel and the piston compartment.

8. The self-inflation device of claim 6, wherein application of centrifugal force by rotation of the tire causes the weight to rotate, and the crankshaft is configured to convert the rotational movement of the weight into linear movement of the first and second connecting rods and thereby cause corresponding reciprocal movement of the plunger and the piston.

9. The self-inflation device of claim 8, wherein:
application of centrifugal force when the self-inflation device is in the rest position causes the weight to rotate to a first rotation position, in which a center of mass of the weight is behind the crankshaft relative to the body, the plunger is at least partially retracted to increase the volume of air entering the sub-pressure compartment from the intake opening, and the piston is at least partially extended such that a sealing component configured on the piston prevents airflow between the interior air channel and the piston compartment and thereby creates the compression chamber;
application of centrifugal force when the self-inflation device is in the first rotation position causes the weight to rotate to a second rotation position, in which the center of mass of the weight is above the crankshaft, the plunger is fully retracted, and the piston is fully extended to the valve opening position to cause the valve to open and air to enter the tire;
and application of centrifugal force when the self-inflation device is in the second rotation position causes the weight to rotate to a third rotation position, in which the center of mass of the weight is parallel to the crankshaft, the plunger is at least partially extended to force air from the sub-pressure compartment into the interior air channel, and the piston is at least partially retracted to form a vacuum in the piston compartment.

10. The apparatus of claim 1, wherein the piston has a piston opening internal to the inner space, the piston is moved to a pulled position by centrifugal force applied by rotation of the tire to open the intake opening in the air intake position, and moved to a pushed position by air pressure from the inner space to block the intake opening and create the compression chamber within the piston compartment in the compression position, and wherein the valve is opened when the piston is in the pushed position.

11. The self-inflation device of claim 10, wherein the piston opening is a channel passing along the piston.

12. The self-inflation device of claim 1, further comprising at least one sealing component positioned around the piston and pressed into the piston compartment.

13. The self-inflation device of claim 12, wherein the at least one sealing component comprises at least one O-ring.

14. The self-inflation device of claim 1, further comprising a screw for adjusting the maximum pressure of the compression chamber.

15. (canceled)

16. The self-inflation device of claim 1, further comprising:
a tire valve portion having a one way inflation channel and an intake channel attached to the intake opening;
wherein the tire valve portion is positioned at a tire valve opening of the tire.

17. The self-inflation device of claim 16, wherein the one way inflation channel includes an inflation valve.

18. The self-inflation device of claim 1, further comprising a mount adapted to fixate the self-inflation device in relation to the tire.

19. The self-inflation device of claim 1, mounted on a rim holding the tire.

20. A method of maintaining pressure in a tire by a self-inflation device, the method comprising:
moving a piston within a piston compartment between an air intake position in which an intake opening fluidically connects the piston compartment and the ambient atmosphere, and a compression position, in which the piston fluidically seals the piston compartment from the intake opening, thereby creating a compression chamber;
opening and closing a valve with the piston, wherein airflow between the compression chamber and the inner space is allowed when the valve is opened and prevented when the valve is closed, and cycling between the air intake and the compression positions, through application of centrifugal force onto the self-inflation device by rotation of the tire.

21. A method as defined in claim 20, wherein the self-inflation device comprises a body, the piston compartment is configured on one side of the body, the self-inflation device further comprises a sub-pressure compartment configured on an opposing side of the body and a plunger slidably configured therein, and an interior air channel within the body for connecting air between the sub-pressure compartment and the piston compartment, wherein the piston compartment is connectable to the intake opening via the sub-pressure compartment and the interior air channel, a first connecting rod extending laterally from the piston along a shaft axis, a second connecting rod extending laterally from the plunger along the shaft axis, a crankshaft configured perpendicular to the first and second connecting rods and extending therebetween, and a weight attached to the crankshaft between the first and second connecting rods, such that rotation of the weight causes corresponding reciprocal movement of the first and second connecting rods, wherein the first connecting rod and second connecting rod are attached to the crankshaft at rotationally opposing positions, such that when the plunger is extended, the piston is retracted, and vice versa, and the method further comprises:
rotating the weight with centrifugal force applied by rotation of the tire;
converting rotational motion of the weight into linear motion of the first and second connecting rods;
and reciprocally moving the plunger and the piston.

22. A method as defined in claim 20, wherein the piston has a piston opening internal to an inner space of the tire, and the method further comprises:
moving the piston to a pulled position by application of centrifugal force applied by rotation of the tire to open the intake opening;
moving the piston to a pushed position by air pressure from the inner space to block the intake opening and create the compression chamber within the piston compartment; and
opening the valve when the piston is in the pushed position.
